(19) United States
(12) Patent Application Publication
(10) Pub. No.: US 2026/0089165 A1
(43) Pub. Date: Mar. 26, 2026

(54) SYSTEMS AND METHODS FOR DATA ACCESSIBILITY AND MANAGEMENT IN A DISTRIBUTED NETWORK

(71) Applicant: BANK OF AMERICA CORPORATION, CHARLOTTE, NC (US)

(72) Inventors: Jose Iturria, Astoria, NY (US); Mark Edward Fowler, Allen, TX (US); Arjun Thimmareddy, Charlotte, NC (US); Ramesh Babu Chandanala, Concord, NC (US); Basantkumar Tiwari, Edison, NJ (US); Amit Beniwal, Jacksonville, FL (US)

(73) Assignee: BANK OF AMERICA CORPORATION, CHARLOTTE, NC (US)

(21) Appl. No.: 18/895,750

(22) Filed: Sep. 25, 2024

(51) Int. Cl. H04L 9/40

(52) U.S. Cl. CPC H04L 63/105; H04L 63/0876

(57) ABSTRACT

Systems, computer program products, and methods are described herein for data accessibility and management in a distributed network. The present disclosure is configured to generate an interaction interface, wherein the interaction interface comprises a channel, and wherein the interaction interface comprises input from a user; receive an attachment, wherein the input comprises the attachment, and wherein the attachment is uploaded to the interaction interface via the user; encrypt the input, wherein encrypting the input comprises securing the input to prevent unauthorized access to the input; store the input in a database, wherein the database is associated with an entity that hosts the interaction interface; and transfer the input to a destination, wherein the destination is chosen by the user, and wherein the destination is a destination device.

### TECHNOLOGICAL FIELD

Example embodiments of the present disclosure relate to systems and methods for data accessibility and management in a distributed network.

### BACKGROUND

There are significant issues associated with conventional data access and management systems. Applicant has identified a number of deficiencies and problems associated with conventional procedures for accessing and managing data. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for data accessibility and management in a distributed network.

Embodiments of the present invention address the above needs and/or achieve other advantages by providing apparatuses (e.g., a system, computer program product, and/or other devices) and methods for data accessibility and management in a distributed network. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention may generate an interaction interface, wherein the interaction interface includes a channel, and wherein the interaction interface includes input from a user. In some embodiments, the present invention may receive an attachment, wherein the input includes the attachment, and wherein the attachment is uploaded to the interaction interface via the user. In some embodiments, the present invention may encrypt the input, wherein encrypting the input includes securing the input to prevent unauthorized access to the input. In some embodiments, the present invention may store the input in a database, wherein the database is associated with an entity that hosts the interaction interface. In some embodiments, the present invention may transfer the input to a destination, wherein the destination is chosen by the user, and wherein the destination is a destination device.

In some embodiments, the present invention may receive, via a user device, an authentication from the user device, wherein the authentication authenticates the user's identity. In some embodiments, the present invention may determine an access level of the user device based on the user's identity and an address associated with the user device. In some embodiments, the present invention may allow the user, via the user device, to access the channel based on the access level of the user device.

In some embodiments, the channel includes a secure channel, wherein the secure channel includes a secure destination that indicates the channel is used to transfer sensitive information, wherein the present invention allows the user, via the user device, to access the secure channel based on the access level of the user device.

In some embodiments, the present invention may receive, via an additional user device, an additional authentication from the additional user device, wherein the additional authentication authenticates the additional user's identity. In some embodiments, the present invention may determine an access level of the additional user device based on the additional user's identity and an address associated with the additional user device. In some embodiments, the present invention may allow the additional user, via the additional user device, to access the channel based on the access level of the additional user device.

In some embodiments, the additional user may be associated with the entity.

In some embodiments, the additional user includes a third party user wherein the third party user is not associated with the entity.

In some embodiments, the channel includes a first channel, and the present invention merges the first channel with a second channel. In some embodiments, merging the first channel with the second channel includes generating a third channel, wherein the third channel combines the first channel and the second channel. In some embodiments, merging the first channel and the second channel includes authorizing the users associated with the first channel and the users associated with the second channel access to the third channel. In some embodiments, merging the first channel and the second channel includes merging the input associated with the first channel and the input associated with the second channel.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for data accessibility and management in a distributed network, in accordance with an embodiment of the disclosure;

FIG. 2 illustrates a process flow for data accessibility and management in a distributed network, in accordance with an embodiment of the disclosure;

FIG. 3 illustrates an example embodiment of a system for data accessibility and management in a distributed network, in accordance with an embodiment of the disclosure; and

FIG. 4 illustrates an example embodiment of a merged channel, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on. ”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration. ” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In the modern world, communication applications are ever-growing, especially within entities and businesses looking for interconnectivity solutions within their companies. Entities may look for third-party platforms and install third-party software into their organizational network to address these concerns. These applications seek to simplify communication among employees and users at an entity by making it easier to communicate with one another as well as share information within the entity. For example, a corporation may look to install such communication application within the organization to assist with communication about specific projects, teams, organization-wide announcements, and the like. However, there are several issues associated with using third-party platforms to perform such functions.

Initially, conventional third-party communication applications may include open-source software, wherein the code that runs the applications may be publicly available. The open-source nature of such applications introduce security concerns about the applications because the code is open to public scrutiny, which may lead to exposing potential vulnerabilities associated with the application. Malicious actors may then take this publicly available information and misappropriate or otherwise harm an entity that has the applications installed. Further, these conventional third-party communication applications typically absolve themselves of responsibility associated with harm caused to the entity using their application. For the entity, this may mean extensive costs if such security concerns arise during operation of the application.

In addition, entities that use conventional third-party communication applications may incur costs and expenses associated with procuring, installing, maintaining, and operating such applications. For example, the entity may be required to pay costs associated with the operation of the application such as subscription costs, licensing costs, and costs associated with additional users or features of the application.

Further, an entity may not control or own the data the entity inputs into conventional third-party communication applications. The entity, or the entity's users, may input information to the application, but, according to terms and conditions of the agreement to use the application, the third-party may control the input data. Further, the third-party may also own the output data of the application, which may lead to issues for the entity. In addition, there may be inconsistencies associated with retention of the input into the third-party communication application. For example, chat logs entered into the application may cease to exist without the entity's approval. Further, such data may be stored on the third-party's servers, which may lead them to cease to exist if the third-party dissolves or ceases to exist, itself. In this regard, an entity in an industry with regulations on data retention may face issues surrounding the use of such conventional third-party communication applications. Therefore, systems and methods for data accessibility and management in a distribute network are introduced.

The disclosure herein provides for a solution that uses decentralized protocols to host communication applications. The solution includes the ability for an entity to own the data the entity, via its employees, vendors, and user, inputs into the application. Further, the entity controls and owns the output from the application, as well. The solution may include an interaction interface which may include a channel that receives input from a user. The channels may have specific designations, such as relating to a specific project, security levels, general communications, or the like. Further, the channels may be able to receive attachments (e.g., documents or files) from the users and share the attachments within the channel.

In addition, users may be able to direct where their input is ultimately transferred to. For example, a user may input an update relating to a project, along with an attachment indicating the project's status. The user may wish for the input to be stored on a secure database within the communication application, and may wish for it to be retrievable at a later date. In this regard, the user may be able to selectively choose where the input's destination is and may update retention settings of the input. Further, the user may be able to choose which device the input is stored on, which may include a local storage of such input (e.g., on the user's own device), on the entity's database, on another user's device, or the like. The input throughout the solution as described herein may be encrypted, with encryption settings configured by the entity or the entity's infrastructure technology (IT) personnel.

In some embodiments, specific channels of the interaction interface may require security clearance via access levels associated with each user. In order for a user to be able to interact (e.g., view, input, receive, etc.) with certain channels (e.g., secure channels), the user may be required to obtain certain access levels. The access levels may, in some embodiments, be determined based on the user's identity and address of the user device. The user device address may include the device's internet protocol (IP) address, media access control (MAC) address, port numbers, uniform resource locator (URL), domain name system (DNS) address, private IP address, geolocation address, or the like. In this regard, secure channels may only allow certain devices to view the channel, or may only allow devices from certain geographic locations to view the channel.

In some embodiments, the channels may be able to be merged, combined, or otherwise integrated with one another. Merging the channels may include merging the user base of each channel and also merging the input of each channel into the merged channel. For example, the chat logs of two channels to be merged may be visible, searchable, and accessible in the merged channel by the now-merged user base of each channel. Further, in some embodiments, the input received across the interaction interface and channels may be used to train artificial intelligence (AI). In this regard, the input data may be fed to an AI training engine, which may configure the AI to learn from the input data, and make updates to the AI based on such input.

What is more, the present disclosure provides a technical solution to a technical problem. As described herein, the technical problem includes issues surrounding conventional third-party communication applications, such as data security, overconsumption of resources, and data ownership. The technical solution presented herein allows for decentralized protocols to host communication applications in order to secure input data, generate transparent data ownership, and effectively use resources associated with the communication applications. In particular, the system as described herein is an improvement over existing solutions to third-party communication applications, (i) with fewer steps to achieve the solution, thus reducing the amount of computing resources, such as processing resources, storage resources, network resources, and/or the like, that are being used (e.g., by allowing an entity to use decentralized protocols to host its own communication application), (ii) providing a more accurate solution to problem, thus reducing the number of resources required to remedy any errors made due to a less accurate solution (e.g., by configuring the communication application for the entity and reducing overhead resources), (iii) removing manual input and waste from the implementation of the solution, thus improving speed and efficiency of the process and conserving computing resources (e.g., by allowing for configurations of the communication application to better suit the needs of the entity), (iv) determining an optimal amount of resources that need to be used to implement the solution, thus reducing network traffic and load on existing computing resources (e.g., through using the communication application to replace existing conventional solutions distributed among third party providers). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the communication application system (e.g., the system 130) as described herein is a solution to the problem of conventional third party communication applications management of data within the platform. Further, the communication application system may be characterized as identifying a specific improvement in computer capabilities and/or network functionalities in response to the communication application system's integration to existing devices, software, applications, and/or the like. In this way, the communication application system improves the capability of a system to provide data ownership, security, and functionality to an entity hosting the communication application system. Further, the communication application system improves the functionality of networks in response to reducing the resources consumed by the system (e.g., network resources, computing resources, memory resources, and/or the like).

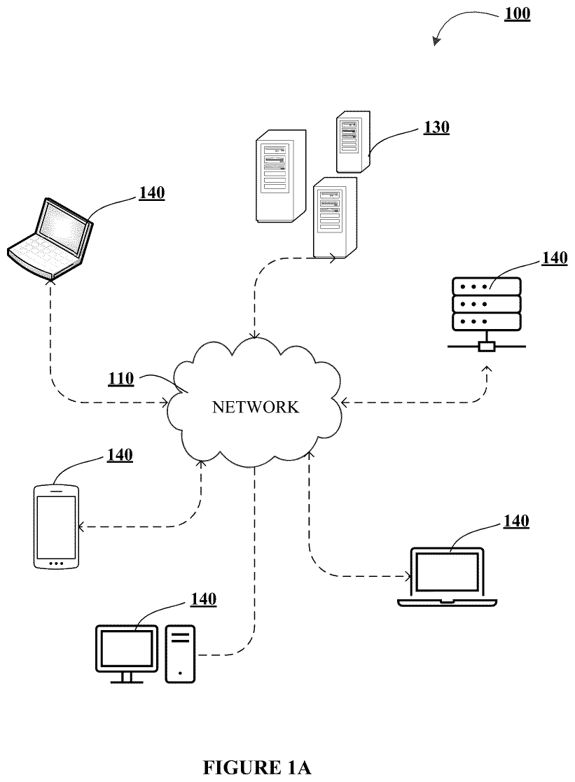

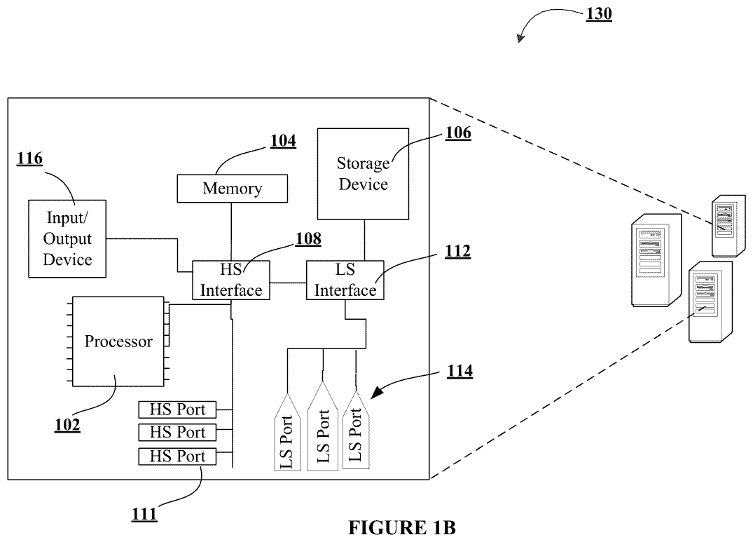

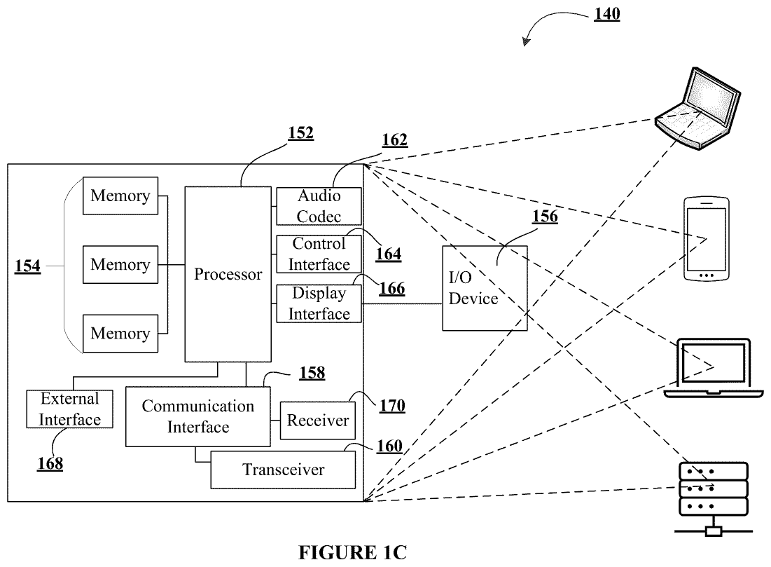

FIGS. 1A-1C illustrate technical components of an exemplary distributed computing environment 100 for data accessibility and management in a distributed network, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

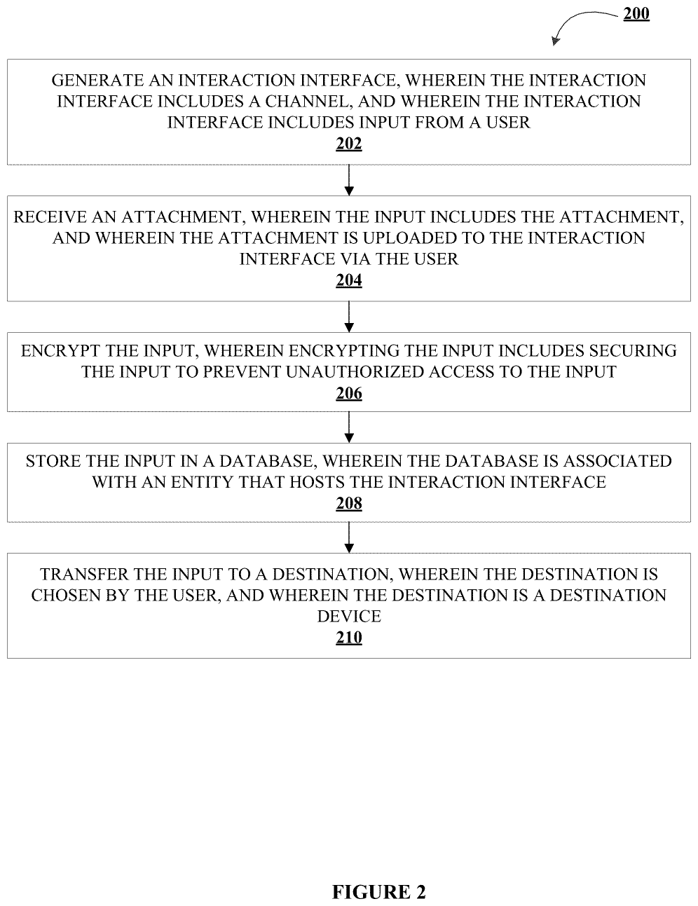

FIG. 2 illustrates a process flow for data accessibility and management in a distributed network, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, the system 130 (e.g., similar to one or more of the systems described herein with respect to FIGS. 1A-1C) may perform one or more of the steps of process flow 200. For example, the system (e.g., the system 130 described herein with respect to FIGS. 1A-1C) may perform the steps of process flow 200.

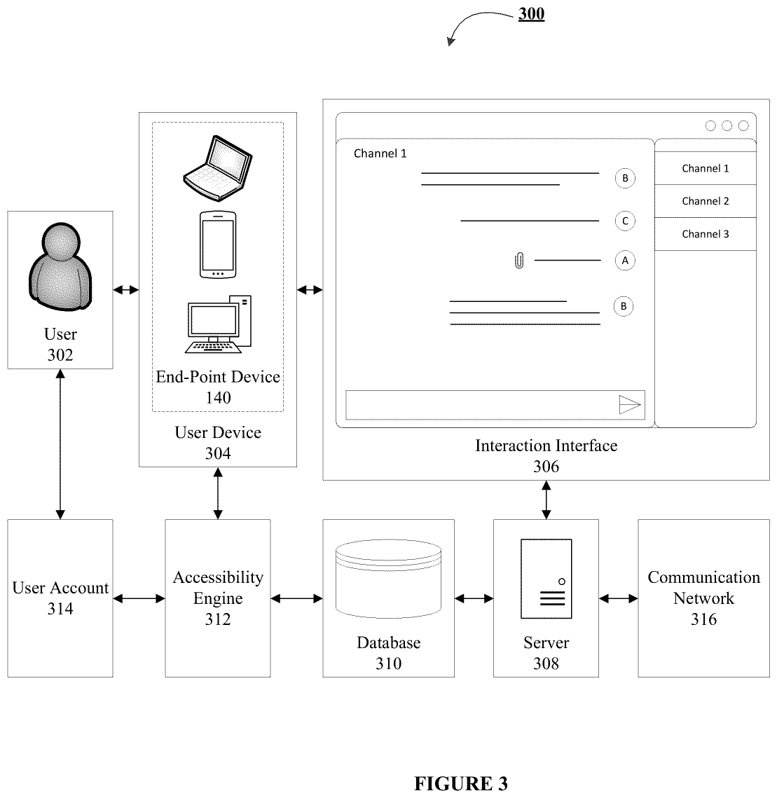

As shown in block 202, the process flow 200 of this embodiment includes generating an interaction interface, wherein the interaction interface includes a channel, and wherein the interaction interface includes input from a user. As shown in FIG. 3, the interaction interface 306 may include an interface displayed on a user device 304. The user device 304 may include an end-point device 140 as described in FIGS. 1A-1C. A user 302 may interact with the interaction interface 306 via the user device 304. The interaction interface 306 may include one or more channels users may interact with. Each of the channels may relate to a task, project, communication, or the like. Further, each channel may include a designated set of users allowed to join and interact with the channel. The users associated with each of the channels may be determined by the entity hosting the system 130, an officer of the entity, an employee of the entity, or the like. Further, the channels may be created, merged, split, deleted, or otherwise configured according to the channel's own rules and regulations. For example, a user may independently join a channel that does not have any rules surrounding adding users to the channel. In another example, if a channel has rules about additional users joining (e.g., access level requirements), the channel may not be joined without compliance with those rules.

As shown in block 204, the process flow 200 of this embodiment includes receiving an attachment, wherein the input includes the attachment, and wherein the attachment is uploaded to the interaction interface via the user. In some embodiments, the input may include various forms of information a user 302 provides or generates while interacting with the communication platform, interaction interface 306, or any associated channel. In this regard, the user may input text, attachments, files, or the like that may be uploaded to the interaction interface 306. In some embodiments, the input may include collaboration among multiple users, input to tools users may use, and the like. For example, the input may include textual data, which may include messages, electronic messages, commands, code portions, or the like. Further, in some embodiments, the input may include audio input, such as voice messages or audio files. In some embodiments, the input may include an attachment, such as a file, document, image, or the like, as discussed in greater detail below. In some embodiments, the input may include communication functionalities, such as a video call, screen sharing, voice call, and the like. Further, in some embodiments, tools such as polls, surveys, project management tools, bug reporting, tracking tools, and the like may also be integrated and included as input.

As shown in block 206, the process flow 200 of this embodiment includes encrypting the input, wherein encrypting the input includes securing the input (and attachments) to prevent unauthorized access to the input. The encryption used in the communication application (e.g., the system 130 as described herein) may include using algorithms such as advanced encryption standard (AES) or Rivest-Shamir-Adleman (RSA) to transform the input into ciphertext. The encryption algorithms may rely on mathematical operations to create a scrambled, unreadable version of the input (e.g., the ciphertext).

In some embodiments, the communication application may use end-to-end encryption methods. The end-to-end encryption may include encrypting the input as the input is transmitted over the network, decrypting the input once it reaches a server, and re-encrypting prior to storing the input. Further, in some embodiments, the encryption may use encryption keys, wherein the entity that is hosting the communication platform is responsible for generating, storing, and protecting the keys. The encryption keys may be managed by designated individuals, employees, technicians, or the like associated with the entity.

In some embodiments, the system 130 as described herein may receive, via a user device, an authentication from the user device, wherein the authentication authenticates the user's identity. In this regard, the user device may authenticate the user's identity prior to the user interacting with the interaction interface 306 or any associated channels. The interaction interface 306 may receive the authentication from the user device 304 and store the authentication to allow the user 302 access. The accessibility engine 312 may use the authentication from the user device 304 and store the authentication in a database 310. In this regard, the system 130 may remember the user device 304 authentication of the user 302 for a future login attempt.

In some embodiments, the accessibility engine 312 may build a user account 314 that is associated with the user 302. The user account 314 may include details and information about the user, such as the user's authentication, access level, secure channels, user device, and the like, as will be discussed in greater detail below. The user account 314 may be used by the system 130 to manage information associated with the user 302 while the user 302 interacts with the interaction interface 306.

In some embodiments, the system 130 as described herein may determine an access level of the user device based on the user's identity and an address associated with the user device. The user's 302 identity may be determined by security features associated with the user device 304. For example, a user device's 304 standard security features may require the user to enter login credentials, passcodes, personal information, or the like to login to the user device 304. These security features may also log the user 302 into the interaction interface 306 by way of communication between the user device 304 and the interaction interface 306. In some embodiments, the interaction interface 306 may include security features of its own that may require the user 302 to enter or re-enter login credentials, which may include but are not limited to, passcodes, biometric information, or the like. In this regard, the interaction interface 306 may include additional security features used for authentication of the user 302. As mentioned above, the accessibility engine 312 may register and store the access level of the user 302 in the user account 314 and/or in the database 310.

Further, in some embodiments, the system 130 may analyze the user device's 304 address. The user device 304 address may include an IP address, a MAC address, a port number, a URL, a DNS address, a private IP address, a geolocation (e.g., geographic coordinates), or the like. In this regard, the user device 304 may be required to meet certain address requirements prior to joining or interacting with the interaction interface 306 or any associated channels. For example, the system 130 may include lists (e.g., allowlists, denylists, etc.) dictating which users, user devices, addresses, and the like, may join the interaction interface 306. In this example, the allowlists and denylists may be stored in the database 310 and may determine which user device addresses are allowed to join the interaction interface 306 or a particular channel. The user account 314 may be updated to reflect the user's 302 associated with the allowlists and denylists. For example, if the user 302 is on a particular channel's denylist, the system 130 may update the user account 314 to be consistent with the channel's denylist.

In this regard, a user 302 attempting to interact with the interaction interface 306 or a channel may be required to be on the allowlist of the system 130 (stored in database 310). The user's 302 identity may be compared to the allowlist to determine whether the user 302, based on the login credentials, is allowed to interact with the interaction interface 306 or channel. The system 130 may block attempts for a user 302 who is on the denylist or who does not meet the allowlist requirements.

Further, the user device 304 may have to meet address requirements of the allowlist prior to joining the interaction interface 306 or a channel. In this regard, the system 130 may compare the user device 304 address (e.g., IP address, MAC address, geolocation address, etc.) with the addresses associated with the allowlist. If the user device 304 has an address on the allowlist, the user device 304 may be able to join the interaction interface 306 or channel. If the user device 304 is on the denylist or cannot meet the requirements of the allowlist, the user device 304 may be blocked from joining. Further, the user account 314 may be updated to reflect the user device's 304 addresses.

In some embodiments, the allowlist and denylist on the database 310 may be configured (e.g., updated, changed, altered, edited, or the like) on a real-time basis. In this regard, the entity may configure the allowlist and denylist. For example, a user 302 may be placed on the allowlist for a particular channel due to an organizational change, a team change of the user 302, an employment change of the user 302, or the like. In this example, if a user 302 changes teams, the user may be placed on the allowlist of the channel relating to the new team while simultaneously placed on the denylist of the old team. The entity may have control over the assignment of users and user devices to the allowlist and denylist as they relate to the interaction interface 306 and the associated channels. Further, the user account 314 may be updated to reflect the change in allowlists and denylists the user is associated with.

In some embodiments, the interaction interface 306 may require a certain access level of the user 302 and/or user device 304 prior to allowing further interaction with the interaction interface 306. The access level may include details relating to allowability regarding certain channels on the interaction interface 306. Further, the access level may be defined by the entity hosting the interaction interface 306.

Further still, in some embodiments, the system 130 may allow the user, via the user device, to access the channel based on the access level of the user device. The access level may include a security clearance level, based upon entity requirements, third-party requirements, regulatory requirements, or the like. The access level may allow or block the user 302 from being allowed to join and interact with the interaction interface 306 altogether or a particular channel. In some embodiments, the allowlist and denylist may be updated to reflect the access level of the user 302.

In some embodiments, the channel includes a secure channel, wherein the secure channel includes a secure designation that indicates the channel is used to transfer sensitive information, wherein the system 130 further allows the user, via the user device, to access the secure channel based on the access level of the user device.

In some embodiments, the secure channel may be designated as a secure channel by the user, the entity, an additional user, or the like. In this regard, the interaction interface 306 may include functionalities that allow the user 302 to include security features relating to the channel designated as a secure channel. For example, the user 302 may, upon designating the channel as a secure channel, require a password for all users interacting with the secure channel. In another example, the secure channel may only allow users and/or user devices to interact with the secure channel from certain addresses or geographic locations. In this regard, the secure channel may block or limit user devices attempting to interact with the secure channel that are outside of the allowable geographic location, for example. For instance, a secure channel may designate the allowable interaction location as within the United States. If a user attempts to interact with the secure channel while the user is outside of the United States, the secure channel may block the interaction. In some embodiments, the allowable geographic interaction location may be specified by the entity, the user, another individual associated with the entity, or the like. Further, in some embodiments, the allowable geographic interaction location may include one or more geographic locations.

Further, in some embodiments, the secure channel may include other security features that protect the input, transfer, storage, and interaction with input associated with the secure channel. For example, the secure channel may include additional and/or more advanced encryption techniques during transfer and storage of the input data, storing the input data in a secure database, or the like.

In some embodiments, the channel may include a first channel, and the system 130 may merge the first channel with a second channel. In some embodiments, merging the first channel with the second channel may include generating a third channel, wherein the third channel combines the first channel and the second channel. In some embodiments, merging the first channel with the second channel may include authorizing the users associated with the first channel and the users associated with the second channel access to the third channel. In some embodiments, merging the first channel with the second channel may include merging the input associated with the first channel and the input associated with the second channel.

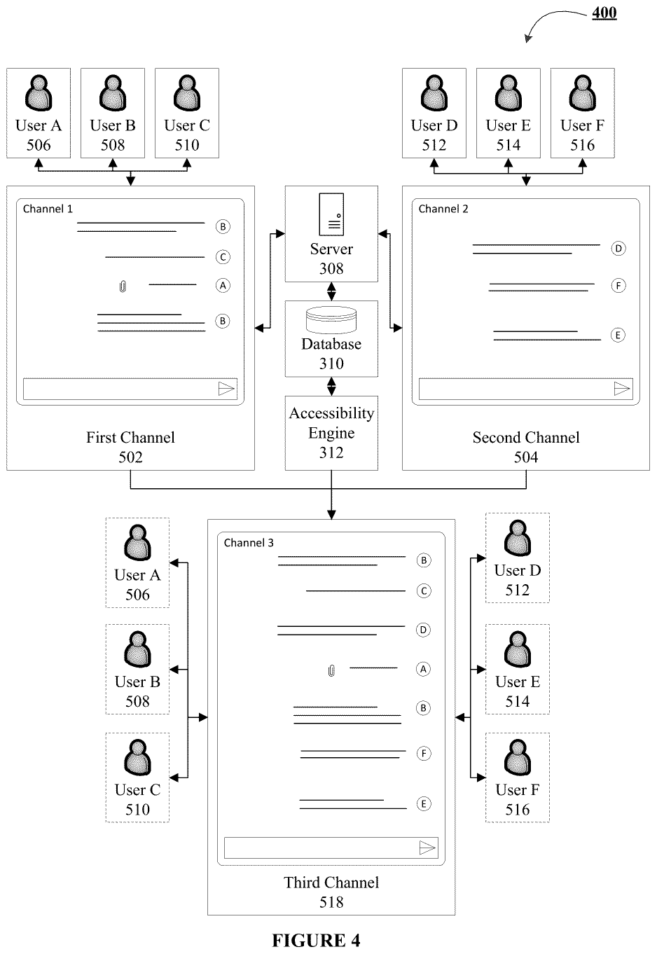

As shown in FIG. 4, a first channel 502 and a second channel 504 may be merged to form a third channel 518. The first channel 502 may have users associated with it (e.g., user A 506, user B 508, and user C 510) along with their user devices (not shown) and user accounts (not shown). Further, the first channel 502 may have its own security features (e.g., a secure channel) and required access level of the users. The second channel 504 may have its own users (e.g., user D 512, user E 514, and user F 516) as well as their user devices (not shown) and user accounts (not shown). Similar to the first channel 502, the second channel 504 may include its own security features and required access level.

Upon merging, the third channel 518 may adopt the security features and access level requirements of the first channel 502, the second channel 504, both of the channels, or neither of the channels. In some embodiments, the third channel 518 may create its own secure channel and access level requirements of the users. The users (e.g., user A 506, user B 508, user C 510, user D 512, user E 514, and user F 516) may or may not all have access to the third channel 518. The users that do have access to the third channel 518 may have their user devices and user accounts updated via the accessibility engine 312. In a specific example, if user A 506 has left the team or the entity, user A's 506 access to the third channel 518 may be blocked or otherwise restricted.

Further, in some embodiments, the input in both the first channel 502 and the second channel 504 may be accessible by the users associated with the third channel 518. In this regard, the input (e.g., historical input) may be searchable and accessible after the channels have merged.

In some embodiments, the system 130 may receive, via an additional user device, an additional authentication from the additional user device, wherein the additional authentication authenticates the additional user's identity. Further, in some embodiments, the system 130 may determine an access level of the additional user device based on the additional user's identity and an address associated with the additional user device. Further still, in some embodiments, the system 130 may allow the additional user, via the additional user device, to access the channel based on the access level of the additional user device. In some embodiments, the additional user may be associated with the entity. In some embodiments, the additional user may include a third-party user wherein the third party user is not associated with the entity.

In some embodiments, the third party user may be a vendor, contractor, outside technician, supplier, or the like. Further, the third party user may require access to the interaction interface 306 or a particular channel to perform services for the entity. In this regard, and in some embodiments, the third party user and the third party user device may be authenticated in the same way as the user 302 and the user device 304 is authenticated and verified. Further, using the system's 130 ability to allow and deny access to user devices (e.g., third-party user devices) based on the device's address promotes efficient use of resources (e.g., networking resources, computing resources, human resources, etc.).

As shown in block 208, the process flow 200 of this embodiment includes storing the input in a database, wherein the database is associated with an entity that hosts the interaction interface. In some embodiments, the database may be associated with the entity hosting the communication application. For example, as shown in FIG. 3, the database 310 may receive the input from a server 308 or the interaction interface 306, including the input generated by the user 302. In some embodiments, the server 308 may also be associated with the entity hosting the communication application. The server 308 may direct the flow of network traffic based on the destination, processes, or actions of the traffic. For example, a user 302 may have a file (e.g., an attachment) the user 302 wishes to share with a team in the interaction interface 306. In this example, the user 302 may upload the file, via the user device 304, to the interaction interface 306. The server 308 may then transfer the file to the database 310 based on the directions of the user 302 and store the file in the database 310. Once stored in the database 310, the file may be accessible by other users of the interaction 306. For example, the other users may retrieve, configure, and interact with the input and attachments stored in the database 310.

In some embodiments, the user 302 may configure input to be made secure and may include security features before the input is accessible by other users. In this regard, the user 302 may password protect or enable other security features of certain input the user 302 uploads to the interaction interface 306. For example, the user 302 may password protect the input sent to a particular channel. Other users wishing to access the input of the user 302 may then be required to enter the password prior to viewing and/or interacting with the input.

As shown in block 210, the process flow 200 of this embodiment includes transferring the input to a destination, wherein the destination is chosen by the user, and wherein the destination is a destination device. In some embodiments, the destination may include a variety of destinations to which the user 302 may transmit input via the communication network 316, as shown in FIG. 3. For example, and as mentioned previously, the user 302 may direct input to be stored in the database 310. Further, the user 302 may direct the input to be transferred to another user's user device. In this way, the input may be transferred over the communication network 316 via the server 308 to another user's device. For example, the user 302 may choose to message another user on the interaction interface 306 and select a channel that includes the other user as the intended recipient of the message. In another example, the user 302 may choose to store an attachment on the database 310, which may include the communication application routing the file to the database 310, assigning a storage path based on user input, updating accessibility permissions based on user input, and the like.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for data accessibility and management in a distributed network, the system comprising:
a processing device;
a non-transitory storage device containing instructions when executed by the processing device, causes the processing device to perform the steps of:
generate an interaction interface, wherein the interaction interface comprises a channel, and wherein the interaction interface comprises input from a user;
receive an attachment, wherein the input comprises the attachment, and wherein the attachment is uploaded to the interaction interface via the user;
encrypt the input, wherein encrypting the input comprises securing the input to prevent unauthorized access to the input;
store the input in a database, wherein the database is associated with an entity that hosts the interaction interface; and
transfer the input to a destination, wherein the destination is chosen by the user, and wherein the destination is a destination device.

2. The system of claim 1, wherein executing the instructions further causes the processing device to:
receive, via a user device, an authentication from the user device, wherein the authentication authenticates the user's identity;
determine an access level of the user device based on the user's identity and an address associated with the user device; and
allow the user, via the user device, to access the channel based on the access level of the user device.

3. The system of claim 2, wherein the channel comprises a secure channel, wherein the secure channel comprises a secure designation that indicates the channel is used to transfer sensitive information, wherein executing the instructions further causes the processing device to allow the user, via the user device, to access the secure channel based on the access level of the user device.

4. The system of claim 1, wherein executing the instructions further causes the processing device to:
receive, via an additional user device, an additional authentication from the additional user device, wherein the additional authentication authenticates the additional user's identity;
determine an access level of the additional user device based on the additional user's identity and an address associated with the additional user device; and
allow the additional user, via the additional user device, to access the channel based on the access level of the additional user device.

5. The system of claim 4, wherein the additional user is associated with the entity.

6. The system of claim 4, wherein the additional user comprises a third party user wherein the third party user is not associated with the entity.

7. The system of claim 1, wherein the channel comprises a first channel, and wherein executing the instructions further causes the processing device to merge the first channel with a second channel, wherein merging the first channel with the second channel comprises:
generating a third channel, wherein the third channel combines the first channel and the second channel;
authorizing the users associated with the first channel and the users associated with the second channel access to the third channel; and
merging the input associated with the first channel and the input associated with the second channel.

8. A computer program product for data accessibility and management in a distributed network, the computer program product comprising a non-transitory computer-readable medium comprising code causing an apparatus to:
generate an interaction interface, wherein the interaction interface comprises a channel, and wherein the interaction interface comprises input from a user;
receive an attachment, wherein the input comprises the attachment, and wherein the attachment is uploaded to the interaction interface via the user;
encrypt the input, wherein encrypting the input comprises securing the input to prevent unauthorized access to the input;
store the input in a database, wherein the database is associated with an entity that hosts the interaction interface; and
transfer the input to a destination, wherein the destination is chosen by the user, and wherein the destination is a destination device.

9. The computer program product of claim 8, wherein the code further causes the apparatus to:
receive, via a user device, an authentication from the user device, wherein the authentication authenticates the user's identity;
determine an access level of the user device based on the user's identity and an address associated with the user device; and
allow the user, via the user device, to access the channel based on the access level of the user device.

10. The computer program product of claim 9, wherein the channel comprises a secure channel, wherein the secure channel comprises a secure designation that indicates the channel is used to transfer sensitive information, wherein executing the instructions further causes the processing device to allow the user, via the user device, to access the secure channel based on the access level of the user device.

11. The computer program product of claim 8, wherein the code further causes the apparatus to:
receive, via an additional user device, an additional authentication from the additional user device, wherein the additional authentication authenticates the additional user's identity;
determine an access level of the additional user device based on the additional user's identity and an address associated with the additional user device; and
allow the additional user, via the additional user device, to access the channel based on the access level of the additional user device.

12. The computer program product of claim 11, wherein the additional user is associated with the entity.

13. The computer program product of claim 11, wherein the additional user comprises a third party user wherein the third party user is not associated with the entity.

14. The computer program product of claim 8, wherein the channel comprises a first channel, and wherein executing the instructions further causes the processing device to merge the first channel with a second channel, wherein merging the first channel with the second channel comprises:
generating a third channel, wherein the third channel combines the first channel and the second channel;
authorizing the users associated with the first channel and the users associated with the second channel access to the third channel; and
merging the input associated with the first channel and the input associated with the second channel.

15. A method for data accessibility and management in a distributed network, the method comprising:
generating an interaction interface, wherein the interaction interface comprises a channel, and wherein the interaction interface comprises input from a user;
receiving an attachment, wherein the input comprises the attachment, and wherein the attachment is uploaded to the interaction interface via the user;
encrypting the input, wherein encrypting the input comprises securing the input to prevent unauthorized access to the input;
storing the input in a database, wherein the database is associated with an entity that hosts the interaction interface; and
transferring the input to a destination, wherein the destination is chosen by the user, and wherein the destination is a destination device.

16. The method of claim 15, wherein the method further comprises:
receiving, via a user device, an authentication from the user device, wherein the authentication authenticates the user's identity;
determining an access level of the user device based on the user's identity and an address associated with the user device; and
allowing the user, via the user device, to access the channel based on the access level of the user device.

17. The method of claim 16, wherein the channel comprises a secure channel, wherein the secure channel comprises a secure designation that indicates the channel is used to transfer sensitive information, wherein executing the instructions further causes the processing device to allow the user, via the user device, to access the secure channel based on the access level of the user device.

18. The method of claim 15, wherein the method further comprises:
receiving, via an additional user device, an additional authentication from the additional user device, wherein the additional authentication authenticates the additional user's identity;
determining an access level of the additional user device based on the additional user's identity and an address associated with the additional user device; and
allowing the additional user, via the additional user device, to access the channel based on the access level of the additional user device.

19. The method of claim 18, wherein the additional user is associated with the entity.

20. The method of claim 15, wherein the channel comprises a first channel, and wherein executing the instructions further causes the processing device to merge the first channel with a second channel, wherein merging the first channel with the second channel comprises:
generating a third channel, wherein the third channel combines the first channel and the second channel;
authorizing the users associated with the first channel and the users associated with the second channel access to the third channel; and
merging the input associated with the first channel and the input associated with the second channel.
